(19) United States
(12) Patent Application Publication
(10) Pub. No.: US 2013/0313732 A1
(43) Pub. Date: Nov. 28, 2013

(54) APPARATUS AND METHOD FOR MANUFACTURING OPTICAL FILM

(71) Applicant: CHIA-LING HSU, Tu-Cheng (TW)

(72) Inventor: CHIA-LING HSU, Tu-Cheng (TW)

(21) Appl. No.: 13/661,127

(22) Filed: Oct. 26, 2012

(30) Foreign Application Priority Data
May 23, 2012 (TW) 101118273

(51) Int. Cl. B29C 35/08; B29C 39/14; B29D 11/00

(52) U.S. Cl. 264/1.38; 425/174.4

(57) ABSTRACT

An apparatus includes a feed hopper containing hot melt UV curable glue, a first pressing roller defining a first central axis, a second pressing roller defining a second central axis, and two UV lamp assemblies received in the two pressing rollers respectively. The first pressing roller rotates about the first central axis in a first direction. The second pressing roller rotates about the second central axis in a second direction opposite to the first direction. The first central axis and the second central axis are arranged on a common horizontal plane and parallel to each other. A molding channel is formed between the two pressing rollers. The two pressing rollers cooperatively press the hot melt UV curable glue flowing into the molding channel from the feed hopper. The UV lamp assemblies emit UV light beams to solidify the pressed UV curable glue to form an optical film.

### BACKGROUND

1. Technical Field

The present disclosure relates to an apparatus for manufacturing an optical film and a method for manufacturing the optical film using the apparatus.

2. Description of Related Art

Optical films, such as diffusion films, brightness enhancement films, or prism sheets are preferred for using in a backlight module for guiding light. An optical film usually includes a number of microstructures. The optical film with the microstructures can be manufactured through a printing method.

However, the above mentioned printing method must employ a polyethylene terephthalate (PET) film as a carrier, on which ultraviolet (UV) curable glue is adhered, and thus increasing a total thickness of the optical film. Furthermore, the light transmission of the optical film is restricted since the light transmission of the PET film is about 90%, not about 100%.

Therefore, it is desirable to provide an apparatus for manufacturing the optical film and a method for manufacturing the optical film using the apparatus, which can overcome or alleviate the above-mention problems.

### BRIEF DESCRIPTION OF THE DRAWINGS

FIG. 1 is a schematic view of an apparatus for manufacturing an optical film, according to a first exemplary embodiment.

FIG. 2 is a flowchart of a method for manufacturing an optical film, according to a second exemplary embodiment.

FIG. 3 is a schematic view of an apparatus for manufacturing an optical film, according to a third exemplary embodiment.

### DETAILED DESCRIPTION

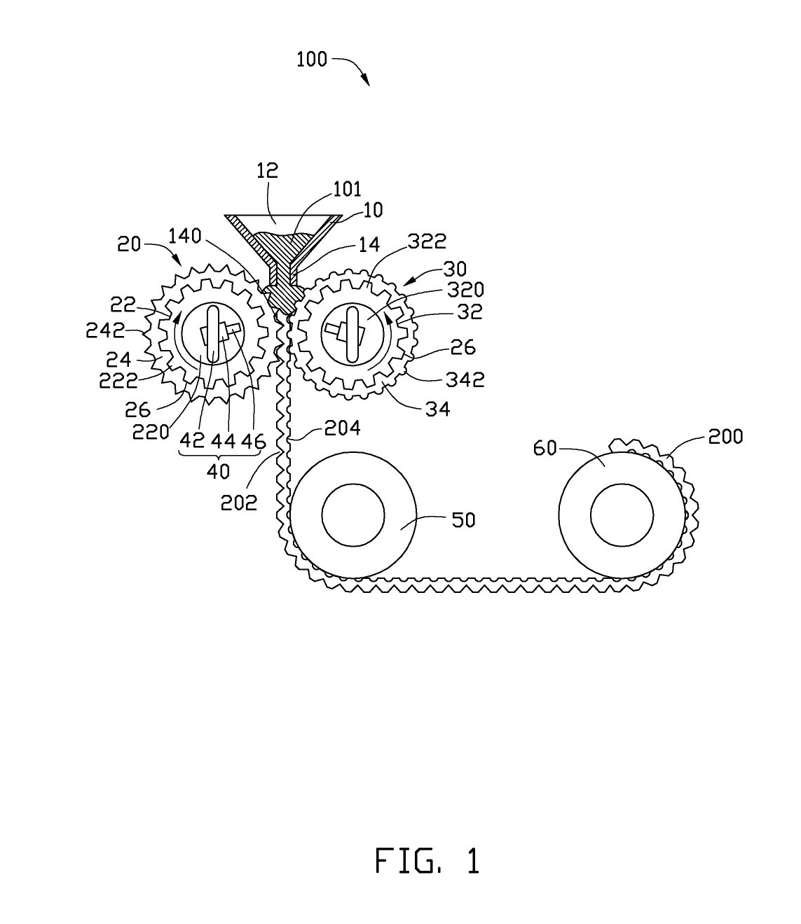

Referring to FIG. 1, an apparatus 100 for manufacturing an optical film 200, according to a first exemplary embodiment, is shown. The apparatus 100 includes a feed hopper 10, a first pressing roller 20, a second pressing roller 30, two UV lamp assemblies 40, a transmission roller 50, and a winding roller 60. In this embodiment, the optical film 200 may be a diffusion film, a brightness enhancement film, or a prism sheet.

The feed hopper 10 is substantially funnel-shaped and configured for containing hot melt UV curable glue 101. The feed hopper 10 includes a mouth 12 and a pipe 14. The hot melt UV curable glue 101 flows into the feed hopper 10 through the mouth 12 and flows out the feed hopper 10 through the pipe 14.

The first pressing roller 20 and the second pressing roller 30 are positioned under the feed hopper 10. The first pressing roller 20 defines a first central axis (not labeled and which is perpendicular to the paper) in a central portion thereof and rotates about the first central axis. The second pressing roller 30 defines a second central axis (not labeled and which is perpendicular to the paper) in a central portion thereof and rotates about the second central axis. The first central axis and the second central axis are arranged on a same plane, such as a common horizontal plane, and parallel to each other. A rotating direction of the first pressing roller 22 is the reverse rotating direction of the second pressing roller 32. In this embodiment, the first pressing roller 22 rotates clockwise, and the second pressing roller 32 rotates counterclockwise.

Specifically, the first pressing roller 20 and the second pressing roller 30 are located nearby each other and spaced at a predetermined distance from each other. A molding channel 140 is formed between the first pressing roller 20 and the second pressing roller 30. The pipe 14 is aligned with the molding channel 140. That is, the longitudinal direction of the pipe 14 coincides with the molding channel 140. The hot melt UV curable glue 101 directly flows into the molding channel 140. The distance between the first pressing roller 20 and the second pressing roller 30 is substantially equal to a predetermined thickness of the optical film 200 to be manufactured.

The first pressing roller 20 and the second pressing roller 30 cooperate to press the hot melt UV curable glue 101. The first pressing roller 20 includes a first main body 22 and a first mold core 24. The first main body 22 is gear typed. In detail, the first main body 22 defines a first cavity 220 in a central portion thereof and a number of first teeth 222 on an outer circumferential surface thereof. The first mold core 24 is sleeved on and firmly adhered to the first main body 22. The first mold core 24 defines a number of first microstructures 242 on an outer circumferential surface thereof. In this embodiment, the first main body 22 is coaxial with the first mold core 24, and the axes of the first main body 22 and the first mold core 24 coincide with the first central axis.

The second pressing roller 30 includes a second main body 32 and a second mold core 34. The second main body 32 is gear typed. In detail, the second main body 32 defines a second cavity 320 in a central portion thereof and a number of second teeth 322 on an outer circumferential surface thereof. The second mold core 34 is sleeved on and firmly adhered to the second main body 32. The second mold core 34 defines a number of second microstructures 342 on an outer circumferential surface thereof. In this embodiment, the second main body 32 is coaxial with the second mold core 34, and the axes of the second main body 32 and the second mold core 34 coincide with the second central axis.

In this embodiment, the first main body 22 and the second main body 32 are made of transparent material, such as silicon dioxide (SiO₂). The first molding core 24 and the second molding core 34 are made of resin of which the molecule chain including fluorine, such as ethylene tetrafluoroethylene (ETFE), or polytetrafluoroethylene (PTFE). The first microstructures 242 and the second microstructures 342 are formed by a roller pressing method. Each of the first microstructures 242 is substantially V-shaped, and each of the second microstructures 342 is substantially dot-shaped. The shape of the first microstructures 242 and the second microstructures 342 are not limited to the above mentioned shape and may be pyramid-shaped or frustum-cone-shaped. In addition, the shape of the first microstructures 242 may be the same as the shape of the second microstructures 342.

The two UV lamp assemblies 40 are received in the first cavity 220 and the second cavity 320, respectively. In detail, the two UV lamp assemblies 40 are positioned in a central portion of the first cavity 220 or the second cavity 320 and apart from the two pressing rollers 20 and 30. That is, the UV lamp assemblies 40 are still when the two pressing rollers 20 and 30 rotate.

Each UV lamp assembly 40 includes a support device 42, a UV lamp 44, and a light guide pipe 46. The support device 42 is fixed in the first cavity 220 or the second cavity 320 using an installation device. The UV lamp 44 is fixed on the support device 42 and configured for solidifying the hot melt UV curable glue 101 pressed by the first pressing roller 20 and the second pressing roller 30. The light guide pipe 46 is flexible and fixed on the UV lamp 44 and configured for guiding UV light beams emitted from the UV lamp 44 toward the pressed UV curable glue 101. The light guide pipe 46 can be bent toward a desired direction to control the UV light emitting direction due to the flexibility of the light guide pipe 46. Therefore, it is convenient to control the UV light emitting direction. In detail, the UV lamp 44 in the first cavity 220 emits UV light beams toward the second pressing roller 30 through the light guide pipe 46 in the first cavity 220. The UV lamp 44 in the second cavity 320 emits UV light beams toward the first pressing roller 20 through the light guide pipe 46 in the second cavity 320.

The transmission roller 50 is a hollow cylinder and positioned under the second pressing roller 30. The transmission roller 50 defines a third central axis (not labeled and which is perpendicular to the paper) in a central portion thereof and rotates about the third central axis. The third central axis and the second central axis are arranged on a same plane, such as a common vertical plane, and parallel to each other. The transmission roller 50 is configured for transmitting the solidified UV curable glue 101 to the winding roller 60.

The winding roller 60 is a hollow cylinder and configured for winding up the solidified UV curable glue 101. The winding roller 60 defines a fourth central axis (not labeled and which is perpendicular to the paper) in a central portion thereof and rotates about the fourth central axis. The fourth central axis and the third central axis are arranged on a same plane, such as a common horizontal plane, and parallel to each other.

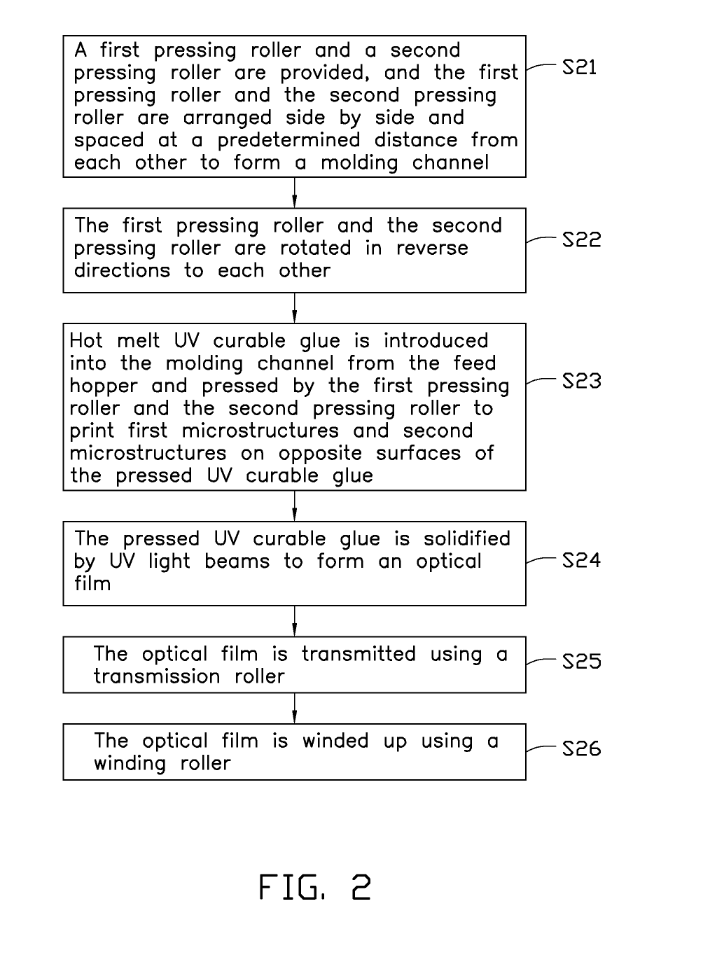

Referring to FIGS. 1-2, a method for manufacturing the optical film 200, according to a second exemplary embodiment, is shown. The method includes the following steps.

In step S21, a first pressing roller 20 and a second pressing roller 30 are provided, and the first pressing roller 20 and the second pressing roller 30 are arranged side by side and spaced at a predetermined distance from each other to form a molding channel 140. Specifically, the first pressing roller 20 includes a first main body 22 and a first mold core 24. The first main body 22 is gear typed. The first main body 22 defines a first cavity 220 in a central portion thereof and a number of first teeth 222 on an outer circumferential surface thereof. The first mold core 24 is sleeved on and firmly adhered to the first main body 22. The first mold core 24 defines a number of first microstructures 242 on an outer circumferential surface thereof. The second pressing roller 30 includes a second main body 32 and a second mold core 34. The second main body 32 is gear typed. The second main body 32 defines a second cavity 320 in a central portion thereof and a number of second teeth 322 on an outer circumferential surface thereof. The second mold core 34 is sleeved on and firmly adhered to the second main body 32. The second mold core 34 defines a number of second microstructures 342 on an outer circumferential surface thereof.

In step S22, the first pressing roller 20 and the second pressing roller 30 are rotated in reverse directions to each other. In this embodiment, the first pressing roller 20 rotates clockwise, and the second pressing roller 30 rotates counterclockwise.

In step S23, hot melt UV curable glue 101 is introduced into the molding channel 140 from the feed hopper 10 and pressed by the first pressing roller 20 and the second pressing roller 30 to print first microstructures 242 and second microstructures 342 on opposite surfaces of the pressed UV curable glue 101.

In step S24, the pressed UV curable glue 101 is solidified by UV light beams to form an optical film 200. This step can be implemented by two UV lamps 44 received in the first pressing roller 20 and the second pressing roller 30. The optical film 200 defines a number of first cutouts 202 on a first surface and a number of second cutouts 204 on a second surface opposite to the first surface. The shape of the first cutouts 202 matches with that of the first microstructures 242, and the shape of the second cutouts 204 matches with that of the second microstructures 342.

In step S25, the optical film 200 is transmitted using a transmission roller 50.

In step S26, the optical film 200 is winded up using a winding roller 60.

The first pressing roller 20, the second pressing roller 30, the transmission roller 50, and the winding roller 60 can be driven by motors (not shown).

In the apparatus 100 and during the steps of the method for manufacturing the optical film 200, a carrier (such as a PET film) is omitted. Therefore, the thickness of the manufactured optical film 200 can be reduced, and the light transmission of the manufactured optical film 200 can be enhanced. Furthermore, the first teeth 222 firmly engage with the first mold core 24, and the second teeth 322 firmly engage with the second cold core 34, thereby avoiding slide of the first mold core 24 and the second mold core 34 when the hot melt UV curable glue 101 is pressed by the first pressing roller 20 and the second pressing roller 30. Moreover, the optical film 200 is easily separated from the first pressing roller 20 and the second pressing roller 30 because the first mold core 24 and the second mold core 34 of PTFE material have good adhesion resistance.

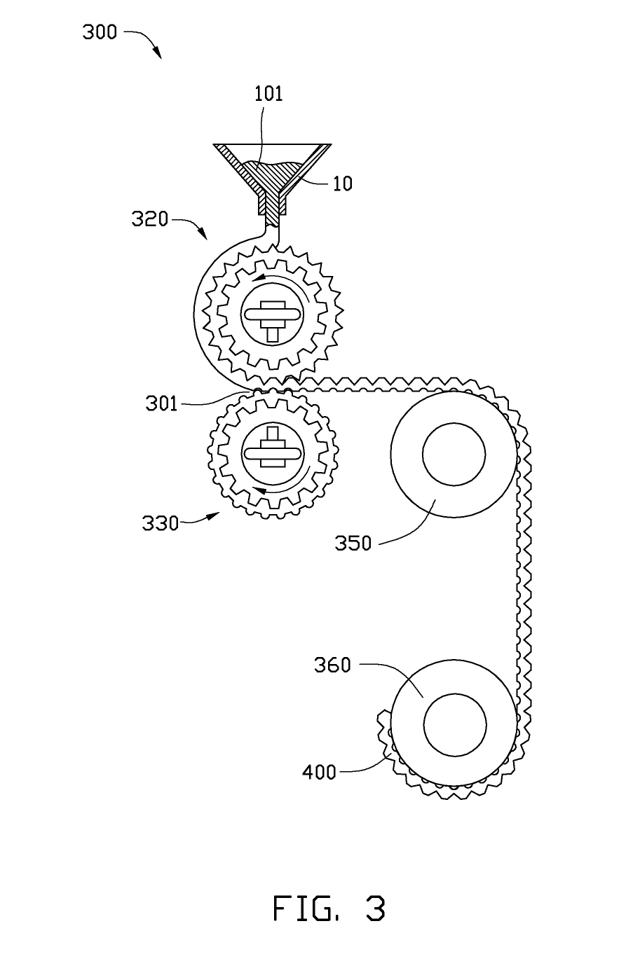

Referring to FIG. 3, an apparatus 300 for manufacturing an optical film 400, according to a third exemplary embodiment, is shown. The differences between the apparatus 300 of this embodiment and the apparatus 100 of the first embodiment are the following: the feed hopper 10 is a precious slot die which can control the thickness of the optical film 400 exactly. The first pressing roller 320 is positioned under the feed hopper 10, and the second pressing roller 330 is positioned under the first pressing roller 320. The first central axis and the second central axis are arranged on a same plane, such as a common vertical plane, and parallel to each other. That is, the feed hopper 10, the first pressing roller 320, and the second pressing roller 330 are arranged along a vertical straight line. The third central axis of the transmission roller 350 and the second central axis are arranged on a same plane, such as a common horizontal plane, and parallel to each other. The winding roller 360 is positioned under the transmission roller 350. The fourth central axis of the winding roller 360 and the third central axis are arranged on a same plane, such as a common vertical plane, and parallel to each other. That is, the transmission roller 350 and the second pressing roller 330 are arranged along a horizontal line, and the transmission roller 350 and the winding roller 360 are arranged along a vertical straight line. When in use, the hot melt UV curable glue 101 from the feed hopper 10 is uniformly distributed on an outer circumferential surface of the first pressing roller 320. The first pressing roller 320 rotates counterclockwise, and the second pressing roller 330 rotates clockwise. The hot melt UV curable glue 101 is adhered on the first pressing roller 320 and then enters into the molding channel 301 between the first pressing roller 320 and the second pressing roller 330. A method for manufacturing the optical film 400 using the apparatus 300 of the third embodiment can refer to the method for manufacturing the optical film 200 of the second embodiment.

Advantages of the apparatus 300 of the third embodiment and the method for manufacturing the optical film 400 using the apparatus 300 of the third embodiment are similar to the advantages of the apparatus 100 of the first embodiment and the method of the second embodiment.

Even though numerous characteristics and advantages of the present embodiments have been set fourth in the foregoing description, together with details of the structures and functions of the embodiments, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. An apparatus for manufacturing an optical film, comprising:
a feed hopper configured for containing hot melt UV curable glue;
a first pressing roller defining a first central axis, the first pressing roller comprising a first main body and a first mold core sleeved and firmly adhered to the first main body, the first main body having a plurality of first teeth on an outer circumferential surface thereof, the first pressing roller configured for rotating about the first central axis in a first direction;
a second pressing roller defining a second central axis, the second pressing roller comprising a second main body and a second mold core sleeved and firmly adhered to the second main body, the second main body defining a plurality of second teeth on an outer circumferential surface thereof, the second pressing roller configured for rotating about the second central axis in a second direction opposite to the first direction, the first central axis and the second central axis arranged on a common horizontal plane and parallel to each other, a molding channel formed between the first pressing roller and the second pressing roller, the first pressing roller and the second pressing roller cooperatively pressing the hot melt UV curable glue flowing through the molding channel from the feed hopper; and
two UV lamp assemblies received in the first pressing roller and the second pressing roller respectively, the UV lamp assemblies configured for emitting UV light beams to solidify the pressed UV curable glue to form the optical film.

2. The apparatus as claimed in claim 1, wherein the first molding core defines a plurality of first microstructures on an outer circumferential surface thereof.

3. The apparatus as claimed in claim 2, wherein the second molding core defines a plurality of second microstructures on an outer circumferential surface thereof.

4. The apparatus as claimed in claim 3, wherein each of the first microstructures is substantially V-shaped, and each of the second microstructures is substantially dot-shaped.

5. The apparatus as claimed in claim 1, wherein the first main body and the second main body are made of SiO₂.

6. The apparatus as claimed in claim 1, wherein the first mold core and the second mold core are made of ETFE or PTFE.

7. The apparatus as claimed in claim 3, further comprising a winding roller, wherein the winding roller is configured for winding up the optical film thereon.

8. The apparatus as claimed in claim 7, further comprising a transmission roller, wherein the transmission roller is configured for transmitting the optical film to the winding roller.

9. The apparatus as claimed in claim 8, wherein the transmission roller defines a third central axis in a central portion thereof, the winding roller defines a fourth central axis in a central portion thereof, the third central axis and the second central axis are arranged on a common vertical plane, and the third central axis and the fourth central axis are arranged on a common horizontal plane.

10. The apparatus as claimed in claim 3, wherein each UV lamp assembly comprises a support device, a UV lamp, and a light guide pipe, the first pressing roller defines a first cavity in a central portion thereof, the second pressing roller defines a second cavity in a central portion thereof, the support device is fixed in the first cavity or the second cavity, the UV lamp is fixed on the support device and configured for emitting UV light beams toward the pressed UV curable glue, and the light guide is fixed on the UV lamp and configured for guiding UV light beams from the UV lamp toward the pressed UV curable glue.

11. The apparatus as claimed in claim 1, wherein the feed hopper is substantially funnel-shaped and comprises a mouth and a pipe, the hot melt UV curable glue flows into the feed hopper from the mouth and flows out the feed hopper from the pipe, the longitudinal direction of the pipe coincides with the molding channel.

12. A method for manufacturing an optical film, comprising:
providing a first pressing roller, a second pressing roller, and two UV lamp assemblies, the first pressing roller and the second pressing roller arranged side by side and spaced a distance from each other to form a molding channel, the first pressing roller comprising a first main body and a first mold core, the first main body defining a first cavity in a central portion thereof and a plurality of first teeth on an outer circumferential surface thereof, the first mold core sleeved on and firmly adhered to the first main body, the first mold core defining a plurality of first microstructures on an outer circumferential surface thereof, the second pressing roller comprising a second main body and a second mold core, the second main body defining a second cavity in a central portion thereof and a plurality of second teeth on an outer circumferential surface thereof, the second mold core sleeved on and firmly adhered to the second main body, the second mold core defining a plurality of second microstructures on an outer circumferential surface thereof, the two UV lamp assemblies received in the first cavity and the second cavity respectively;
rotating the first pressing roller and the second pressing roller, and a rotating direction of the first pressing roller being reverse to that of the second pressing roller;
introducing hot melt UV curable glue into the molding channel and pressing the hot melt UV curable glue using the first pressing roller and the second pressing roller to print first microstructures and second microstructures on opposite surfaces of the pressed UV curable glue;
solidifying the pressed UV curable glue using UV light beams emitted from the UV lamp assemblies to form the optical film.

13. The method as claimed in claim 12, further comprising:
winding up the optical film on a winding roller.

14. The method as claimed in claim 13, further comprising:
transmitting the optical film using a transmission roller toward the winding roller before winding up the optical film.

15. An apparatus for manufacturing an optical film, comprising:
a feed hopper configured for containing hot melt UV curable glue;
a first pressing roller defining a first central axis, the first pressing roller comprising a first main body and a first mold core sleeved and firmly adhered to the first main body, the first main body having a number of first teeth on an outer circumferential surface thereof, the first pressing roller configured for rotating about the first central axis in a first direction;
a second pressing roller defining a second central axis, the second pressing roller comprising a second main body and a second mold core sleeved and firmly adhered to the second main body, the second main body defining a number of second teeth in an outer circumferential surface thereof, the second pressing roller configured for rotating about the second central axis in a second direction contrary to the first direction, the first central axis and the second central axis arranged on a common vertical plane and parallel to each other, a molding channel formed between the first pressing roller and the second pressing roller, the first pressing roller and the second pressing roller cooperatively pressing the hot melt UV curable glue flowing into the molding channel from the feed hopper; and
two UV lamp assemblies received in the first pressing roller and the second pressing roller respectively, the UV lamp assemblies configured for emitting UV light beams to solidify the pressed UV curable glue to form the optical film.

16. The apparatus as claimed in claim 15, wherein the first molding core defines a plurality of first microstructures on an outer circumferential surface thereof.

17. The apparatus as claimed in claim 16, wherein the feed hopper, the first pressing roller, and the second pressing roller are arranged along a vertical straight line.

18. The apparatus as claimed in claim 17, wherein the second molding core defines a plurality of second microstructures on an outer circumferential surface thereof.

19. The apparatus as claimed in claim 18, wherein each of the first microstructures is substantially V-shaped, and each of the second microstructures is substantially dot-shaped.

20. The apparatus as claimed in claim 17, further comprising a winding roller configured for winding up the optical film and a transmission roller configured for transmitting the optical film to the winding roller, wherein the transmission roller defines a third central axis in a central portion thereof, the winding roller defines a fourth central axis in a central portion thereof, the third central axis and the second central axis are horizontally aligned with each other, and the third central axis and the fourth central axis are vertically aligned with each other.
